(19) United States
(12) Patent Application Publication
(10) Pub. No.: US 2012/0021159 A1
(43) Pub. Date: Jan. 26, 2012

(54) TRANSPARENT TOUCH PANEL WITH IMPROVED CURED ADHESIVENESS

(75) Inventors: I-HAU YEH, TAIPEI CITY (TW); MIN-SHU WANG, TAIPEI CITY (TW); SHIH-FENG HUANG, HSINCHU CITY (TW)

(73) Assignee: ELAN MICROELECTRONICS CORPORATION, HSINCHU (TW)

(21) Appl. No.: 13/184,602

(22) Filed: Jul. 18, 2011

(30) Foreign Application Priority Data
Jul. 23, 2010 (TW) 099124357

(51) Int. Cl. B32B 3/10; B32B 3/02; B32B 3/24

(52) U.S. Cl. 428/38; 428/203; 428/137

(57) ABSTRACT

A transparent touch panel includes a light-pervious substrate, conductive traces on the light-pervious substrate, a protective layer on the conductive traces, and a cured adhesive between the conductive traces and the protective layer for bonding them together. The conductive trace has a light-pervious area to allow the ultraviolet light for curing the adhesive to pass and reach the adhesive behind the conductive trace during the ultraviolet light treatment to the adhesive, and thus improve the cured level of the adhesive.

### FIELD OF THE INVENTION

The present invention is related generally to a transparent touch panel and, more particularly, to a structure of a transparent touch panel helpful to adhesive curing of the transparent touch panel.

### BACKGROUND OF THE INVENTION

As shown in FIG. 1, the conventional transparent touch panel 10 includes a light-pervious Indium Tin Oxide (ITO) sensor 12 whose border has a wiring area for disposing metal traces 14 that are connected to the ITO sensor 12 for output of sensed values generated by the ITO sensor 12. FIG. 2 is a partial, cross-sectional view of the wiring area of the transparent touch panel 10 shown in FIG. 1, in which the metal traces 14 are formed on a light-pervious substrate 16, and a protective layer 22 is attached onto the metal traces 14 by a cured adhesive 18 to protect the metal traces 14. The protective layer 22 provides a touch plane for objects to touch. For the sake of esthetic looking, the protective layer 22 is covered by an opaque frame film 20 to hind the metal traces 14 from users' vision. The light-pervious substrate 16 and the protective layer 22 may both be made of glass.

In the process of curing the adhesive 18, due to the presence of the opaque frame film 20 on the protective layer 22, as shown in FIG. 2, the ultraviolet (UV) light for curing the adhesive 18 can only be projected to the adhesive 18 through the light-pervious substrate 16. After absorbing adequate energy, the adhesive 18 is cured to become a solid interlayer structure 24. Typically, the adhesive 18 is liquid glue or optically clear adhesive (OCA). However, the metal traces 14 on the light-pervious substrate 16 is not pervious to light, and thus blocks the UV light to reach the adhesive 18 therebehind, so that the adhesive 18 behind the metal traces 14 can not absorb adequate energy during the UV-light treatment, and thus can not be fully cured. The uncured adhesive 18 becomes sticky composition 26 that will flow along the metal traces 14 and lead to nonuniform thickness of the resultant touch panel or bubbles in the resultant touch panel to degrade the esthetic appearance of the final product. In addition, as the adhesive 18 behind the metal traces 14 is not fully cured and thus has poor adhesiveness, the metal traces 14 and the protective layer 22 will easily depart from each other during subsequent processes due to the poor bonding strength therebetween.

Therefore, it is desired a transparent touch panel having a structure helpful to adhesive curing of the transparent touch panel.

### SUMMARY OF THE INVENTION

An objective of the present invention is to provide a transparent touch panel having a structure helpful to adhesive curing of the transparent touch panel.

Another objective of the present invention is to provide a transparent touch panel with improved cured adhesiveness.

According to the present invention, a transparent touch panel includes a light-pervious substrate, a conductive trace on the light-pervious substrate, a protective layer on the conductive trace, and a cured adhesive between the conductive trace and the protective layer for bonding them together, wherein the conductive trace has a light-pervious area to improve the cured level of the adhesive.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a schematic diagram showing the ITO sensor and wiring area of a conventional transparent touch panel;

FIG. 2 is a partial, cross-sectional view of the wiring area shown in

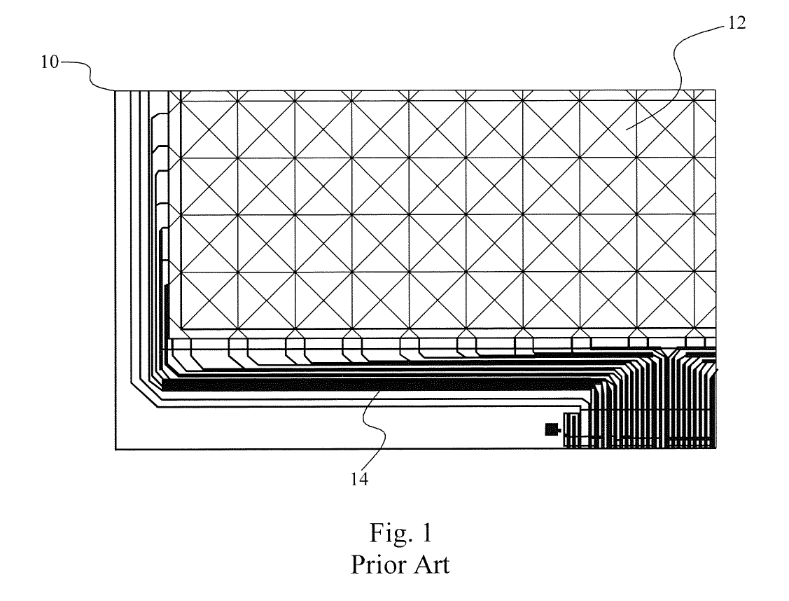

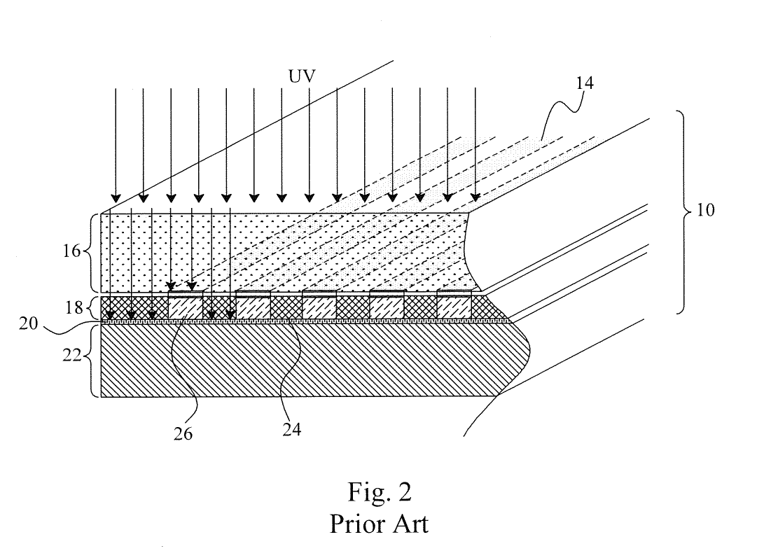

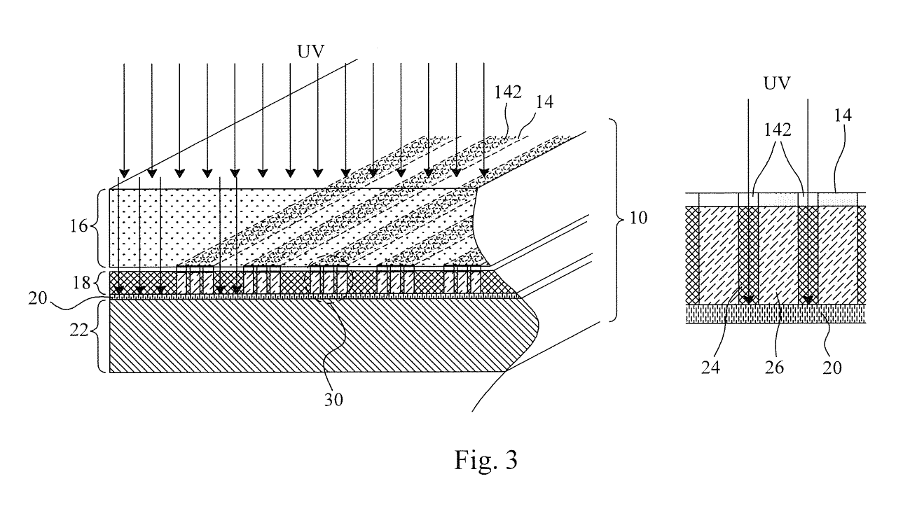

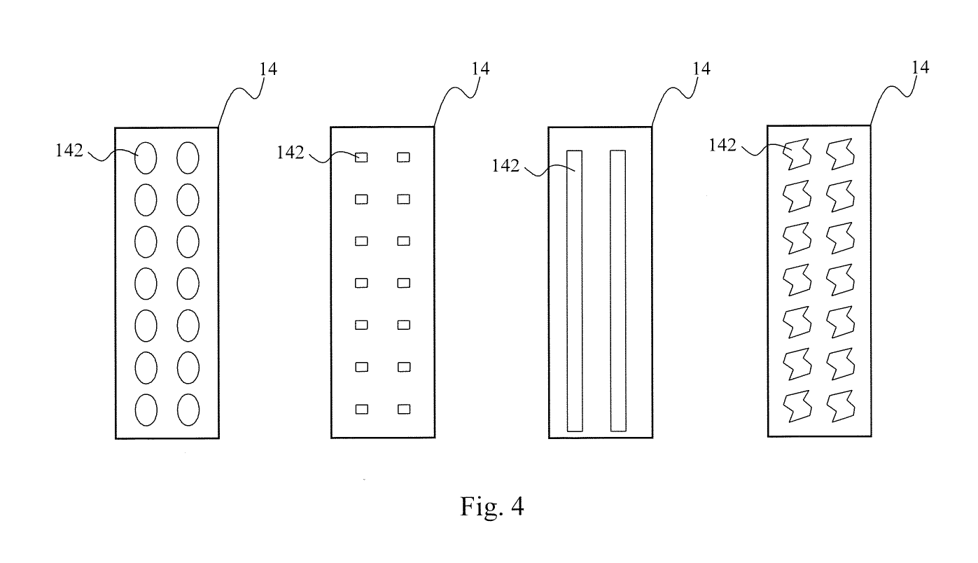

FIG. 1;

FIG. 3 is a partial, cross-sectional view of the wiring area in an embodiment according to the present invention; and

FIG. 4 shows several embodiments for the light-pervious area on the conductive trace shown in FIG. 3.

### DETAILED DESCRIPTION OF THE INVENTION

FIG. 3 shows an embodiment according to the present invention, in which the left diagram is a partial, cross-sectional view of the wiring area of a transparent touch panel 10, and the right diagram is an enlarged view of a part 30 in the left diagram. As the same as a conventional one, the transparent touch panel 10 shown in FIG. 3 has conductive traces 14, a light-pervious substrate 16, a cured adhesive 18, an opaque frame film 20 and a protective layer 22. Each conductive trace 14 has a light-pervious area 142 to allow UV light to pass and thus reach the adhesive 18 behind the conductive trace 14 during the UV-light treatment, so that the adhesive 18 under the light-pervious area 142 can be fully cured and thus become strong interlayer structure 24 that may block sticky composition 26 from flowing and thereby prevent nonuniform thickness of and bubbles in the resultant touch panel and secure the conductive traces 14 and the protective layer 22 from undesired separation. Furthermore, the opaque frame film 20 on the protective layer 22 may be made of reflective material to reflect the UV light to the adhesive 18 for accelerating the curing of the adhesive 18. In the curing process, the UV light may come from various directions and refract at the interface between different materials, so that the opaque frame film 20 made of reflective material can reflect the UV light to somewhere it otherwise could not reach, thereby maximizing the overall area of the interlayer structure 24.

The light-pervious area 142 of the conductive trace 14 may be formed by using a mask that has the pattern of the light-pervious area 142 during the conventional process, without any extra procedures. For not causing impedance variance of the conductive trace 14, the light-pervious area 142 may be appropriately adjusted. The light-pervious area 142 may be made into various geometries, for example, including regular shaped subareas, such as circle, elliptic, square and stripe, or any irregular shaped subareas. FIG. 4 shows several embodiments for the light-pervious area 142 on the conductive trace 14. The conductive trace 14 may be made of single metal material, such as chromium, copper, titanium, tin and aluminum, or any alloy thereof. Each light-pervious area 142 may be a through hole, or may be additionally filled with a material pervious to visible light or a material pervious to non-visible light, such as non-metal materials, e.g. glass, plastic, organic matter, inorganic matter and rubber.

While the present invention has been described in conjunction with preferred embodiments thereof, it is evident that many alternatives, modifications and variations will be apparent to those skilled in the art.

Accordingly, it is intended to embrace all such alternatives, modifications and variations that fall within the spirit and scope thereof as set forth in the appended claims.

What is claimed is:

1. A transparent touch panel comprising:
a light-pervious substrate;
a conductive trace on the light-pervious substrate, having a light-pervious area;
a protective layer on the conductive trace; and
a cured adhesive between the protective layer and the conductive trace.

2. The transparent touch panel of claim 1, wherein the light-pervious area has subareas of a regular shape.

3. The transparent touch panel of claim 2, wherein the regular shape is circle, elliptic, square or stripe.

4. The transparent touch panel of claim 1, wherein the light-pervious area has subareas of an irregular shape.

5. The transparent touch panel of claim 1, wherein the light-pervious area is a through hole.

6. The transparent touch panel of claim 1, wherein the light-pervious area is filled with a material pervious to visible light or pervious to non-visible light.

7. The transparent touch panel of claim 6, wherein the material filled in the light-pervious area is a non-metal material.

8. The transparent touch panel of claim 7, wherein the non-metal material is glass, plastic, organic matter, inorganic matter or rubber.

9. The transparent touch panel of claim 1, wherein the conductive trace comprises a metal material.

10. The transparent touch panel of claim 9, wherein the metal material is chromium, copper, titanium, tin, aluminum, or any alloy thereof.

11. The transparent touch panel of claim 1, further comprising an opaque frame film between the protective layer and the cured adhesive.

12. The transparent touch panel of claim 11, wherein the opaque frame film comprises a reflective material.

13. The transparent touch panel of claim 1, wherein the cured adhesive is a liquid glue or optically clear adhesive.
